(19) United States
(12) Patent Application Publication
(10) Pub. No.: US 2016/0065068 A1
(43) Pub. Date: Mar. 3, 2016

(54) BUCK CONVERTER WITH A STABILIZED SWITCHING FREQUENCY

(71) Applicant: ZENTRUM MIKROELEKTRONIK DRESDEN AG, Dresden (DE)

(72) Inventors: Adrian WARD, Parteen, Co. Clare (IE); Anthony KELLY, Old Kildimo, Co. Limerick (IE)

(21) Appl. No.: 14/784,299

(22) PCT Filed: Apr. 16, 2014
(86) PCT No.: PCT/EP2014/057827

§ 371 Date: Oct. 14, 2015

(30) Foreign Application Priority Data
Apr. 18, 2013 (EP) 13164334.8

(51) Int. Cl. H02M 3/158

(52) U.S. Cl. CPC H02M 3/158

(57) ABSTRACT

A switchable buck-converter with zero voltage switching capability includes a non-linear inductor having an inductance as a function of a load current to allow for a constant switching frequency operation of the switchable buck-converter.

### FIELD OF THE INVENTION

The present invention relates to a sub-boundary conduction mode (SBCM) zero voltage switching buck converter with a stabilized switching frequency.

### BACKGROUND OF THE INVENTION

Buck voltage conversion has been widely adopted in integrated in circuits in order to distribute power from a DC power supply to its points of load. Typically, a buck converter is driven by a pulse width modulation (PWM) control circuit driving a switchable power stage of the buck converter. The PWM duty cycle is designed to accommodate the required voltage reduction.

FIG. 1 shows a state-of-the art buck converter comprising a high-side switch 11 with a respective high-side control 17, a low-side switch 12 with a respective low-side control 18, an inductor 15 connected to a switch node 13, an capacitor 16 connected to the inductor 15 and ground 14. In a charge phase the high-side switch 11 is switched on and the low-side switch 12 is switched off. The capacitor 16 is charged via the inductor 15. In a discharge phase the high-side switch 11 is switched off and the low-side-switch 18 is switched on. Typically, the switches are implemented as metal-oxide semiconductor field effect transistors (MOSFETs). In those MOSFETs switching losses occur when switching from the discharge phase to the charge phase. As the high-side MOSFET is turned on and the low-side MOSFET is turned off, a very high current flows through the MOSFET pair, since the low-side MOSFET's body diode appears as a short circuit during its reverse recovery time. Other losses arise due to discharging of the high-side MOSFET output capacitance, and to reverse recovery in the low-side MOSFET. These losses increase as the switching frequency or input voltage increases. In order to overcome these losses, zero voltage switching has been adopted for buck converters. While still PWM based, a separate phase is added to the PWM timing to allow for ZVS operation. This eliminates the high current body conduction prior to switching on the high-side MOSFET, bringing the drain-source voltage of the high-side MOSFET to zero or nearly zero and producing no high current spikes or damaging ringing. Zero voltage scaling applied to the high-side MOSFET removes its Miller effect at switching on, allowing the use of a smaller driver and lower gate drive. Utilizing the added phase, zero voltage scaling may be implemented by a clamp switch 19 and circuit resonance to operate the high-side MOSFET and synchronous the low-side MOSFET efficiently with soft switching, avoiding the losses they incur during conventional PWM operation and timing.

The SBCM buck converter thus exhibits near zero switching losses when compared to a conventional hard switched system. This allows operation at greater switching frequencies and an overall reduction in the size of the associated passive components.

However, this mode of operation requires either a switching frequency that is inversely proportional to a load current or a constant frequency and an inductor ripple current of at least two times of a maximum output current as will be explained.

The power throughout of the SBCM buck converter may be expressed as:

$${P}_{0} = \frac{Δ {I}_{L}}{2} {V}_{0} = {V}_{0} {I}_{0} \qquad ( 1 )$$

where V₀ is the output voltage, l₀ is the output current

$$Δ {I}_{L} = \frac{{V}_{0} {D}^{′}}{{L}_{0} {f}_{sw}} = 2 {I}_{0} and {D}^{′} = 1 - \frac{{V}_{0}}{{V}_{in}} .$$

L₀ is the inductance of the output inductor, ƒ_{SW} is the switching frequency and Vᵢₙ is the input voltage.

From Eq. (1) it can be seen that the power throughput for a given output voltage is proportional to half the output inductor current Δl_{L}.

The switching frequency ƒ_{SW} may be expressed as:

$${f}_{sw} = \frac{{V}_{0} {D}^{′}}{2 {I}_{0} {L}_{0}} \qquad ( 2 )$$

From Eq. (2) it is apparent, that for a changing load current with a constant inductance L₀ the switching frequency will change inversely proportionally to the changing load current l₀ as shown in FIG. 2.

This variable frequency operation may be addressed by designing L₀ to give an inductor current Δl_{L} of 2l_{0MAX} resulting in a constant frequency operation. Then, the switching frequency may expressed as:

$${f}_{sw} = \frac{{V}_{0} {D}^{′}}{2 {I}_{0 MAX} {L}_{0}} \qquad ( 3 )$$

The root mean squared (RMS) component of this waveform is given by:

$${I}_{RMS} = \sqrt{{( 2 {I}_{0 MAX} \sqrt{\frac{1}{12}} )}^{2}} + {I}_{0}^{2} \qquad ( 4 )$$

Eq. 4 shows there is a constant RMS component of the inductor current that is independent of the output current l₀ giving rise to unacceptable losses at lower output currents.

Thus, the prerequisites of a switching frequency that is inversely proportional to a load current or a constant frequency and an inductor ripple current of at least two times of a maximum output current can be a major limitation of the overall performance.

Hence, what is needed is a solution overcoming the drawbacks stated above. Specifically, what is needed is a solution having lower losses compared to current solutions when operating with a constant switching frequency.

### DISCLOSURE OF THE INVENTION

This solution is achieved with a buck-converter according to the independent claim. Dependent claims relates to further aspects of the present invention.

The present invention relates to a switchable buck-converter with zero voltage switching capability comprising a non-linear inductor having an inductance as a function of a load current designed to allow for a constant switching frequency operation of the switchable buck-converter.

In order to maintain an essentially constant switching frequency ƒ_{SW} for a load current change the inductance L₀ must be a function of the load current. This changing inductance with a load current is achieved by means of the non-linear inductor.

As the inductor changes its inductance as a function of the load current, the RMS output current becomes:

$${I}_{RMS} = \sqrt{{( 2 {I}_{0} \sqrt{\frac{1}{12}} )}^{2}} + {I}_{0}^{2} \qquad ( 5 )$$

From Eq. 5 it is clear that the RMS value of the inductor current is proportional to the load current l₀, thus the losses are proportional to load power. Hence, no losses independent of l₀ occur.

A non-linear inductance designed to allow for a constant switching operation may be provided to all members or derivatives of the buck converter, when used with synchronous rectifiers, such as forward converters, push pull converters, full and half bridge converters.

The switchable buck converter may comprise an output stage for generating an output voltage according to a control signal and an input voltage by means of a switching element comprising a high-side switch and a low-side switch, each having respective first and second main terminals and a respective control terminal driven by a respective driver configured according the control signal. The first low-side main terminal may be connected to ground. The second low-side main terminal and the first high-side main terminal may be connected to a switch node. The second high-side main terminal may be connected to an input voltage terminal. The output stage comprises the non-linear inductor connected to the switch node. The output capacitor may be connected to ground. The buck-converter is operable in a charge phase with the high-side switch being switched on and the low-side switch being switched off. The buck-converter is further operable in a discharge phase with the high-side switch being switched off the low-side switch being switched on. The drivers ate configured to implement zero voltage switching by allowing an inductor current flowing to the switch node such that a voltage drop across the high-side switch is nearly zero when switching from the discharge phase to the charge phase. The high-side switch and the low-side switch may be implemented as MOSFETs.

One aspect of the present invention relates to the zero voltage switching property of the switchable buck converter as this eliminates switching losses found in conventional buck conveners. To achieve this it is necessary to allow the inductor current to pass through zero to reach a negative value of sufficient magnitude to drive the switch node potential, i.e. the switch node capacitance, back to the input voltage prior to switching on the high-side switch. A negative inductor current is an inductor current flowing to the switch node. Thus, the inductor current reverses its direction as it becomes negative. Hence, the low-side driver is configured to implement zero voltage switching by keeping the low-side switched on until a potential of the switch node equals the input voltage.

This may be achieved by measuring the inductor current during the inductor current reversal period and controlling the switch-time of the low-fluid switch by means of a latched switch drive signal. The drive signal remains latched until an input voltage sensitive threshold has been reached with a threshold level being that required to ensure zero voltage scaling operation over a full input voltage range.

### BRIEF DESCRIPTION OF THE DRAWINGS

Reference will be made to the accompanying drawings, wherein:

FIG. 1 shows a state of the art SBCM buck converter.

FIG. 2 shows a diagram showing switching frequency versus output current for a buck converter.

FIG. 3 shows a SBCM buck converter with a non-linear inductor;

FIG. 4 shows a diagram showing the inductor current, the switch node voltage and the high-side switch voltage;

FIG. 5 shows a diagram showing an ideal inductance to load current relationship to maintain a constant switching frequency;

FIG. 6 shows a magnetization curve of a magnetic material including a linear region, a saturation controlled region and a saturated region;

FIG. 7 shows a diagram showing a calculated inductance variance curve of a non-linear inductor design and the ideal inductance; and

FIG. 8 shows a diagram showing a comparison between switching frequency dependency to load current for a linear and non-linear inductor.

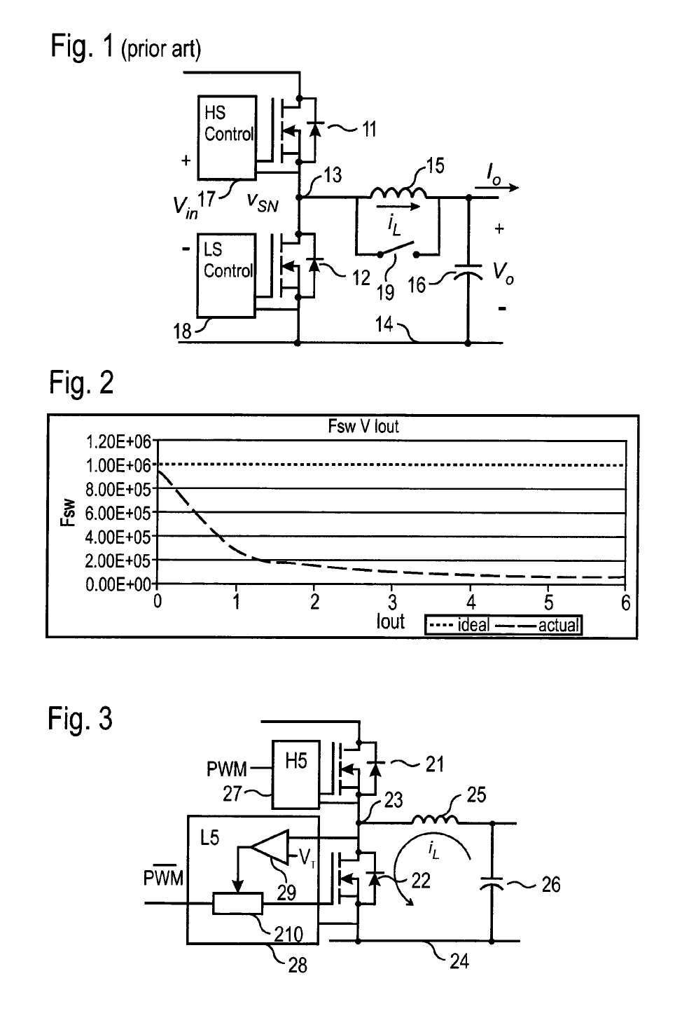

### DETAILED DESCRIPTION OF THE INVENTION

FIG. 3 shows a SBCM buck converter comprising an output stage with a non-linear inductor 25 and a capacitor 26. The output stage generates an output voltage according to a control signal and an input voltage. The switchable buck converter comprises a high-side switch 21 and a low-side switch 22, each having respective first and second main terminals and a respective control terminal driven by a respective driver 27, 28 configured according the control signal. The control signal is a pulse width modulation signal. A drive signal of the high-side switch 21 corresponds to the PWM signal and the drive signal of the low-side switch 22 corresponds to the complement of the PWM signal. The first low-side main terminal is connected to ground. The second low-side main terminal and the first high-side main terminal are connected to a switch node 23. The second high-side main terminal is connected to an input voltage terminal. The output stage comprises the non-linear inductor 25 connected to the switch node 23. The output capacitor 26 is connected to ground. The switchable buck-converter is operable in a charge phase with the high-side switch 21 being switched on and the low-side switch 22 being switched off. The switchable buck-converter is further operable in a discharge phase with the high-side switch 21 being switched off the low-side switch 22 being switched on.

The low-side switch driver 28 for driving the low-side switch 22 is configured to implement zero voltage switching by keeping the low-side switch 22 switched on until a voltage drop across the low-side switch exceeds a threshold. The low-side driver 28 comprises means for sensing the voltage drop across the low-side switch 22, a comparator 29 for comparing the voltage drop across the low-side switch 22 against the threshold V₁ and a latch 210 for latching a drive signal of the low-side driver 210 until the voltage drop across the low-side switch exceeds the threshold V₁ when the inductor current flows to the switch node 23. The drive signal of the low-side switch 22 is a complement of a PWM signal that is latched prior to switching from a discharge phase to a charge phase. The drive signal of the high-side switch 21 corresponds to the PWM signal and is generated by the high-side driver 27. The zero voltage switching implemented by the switch drives 27, 28 results in a near zero voltage drop across the high-side switch when switching the power converter from the discharge phase to the charge phase.

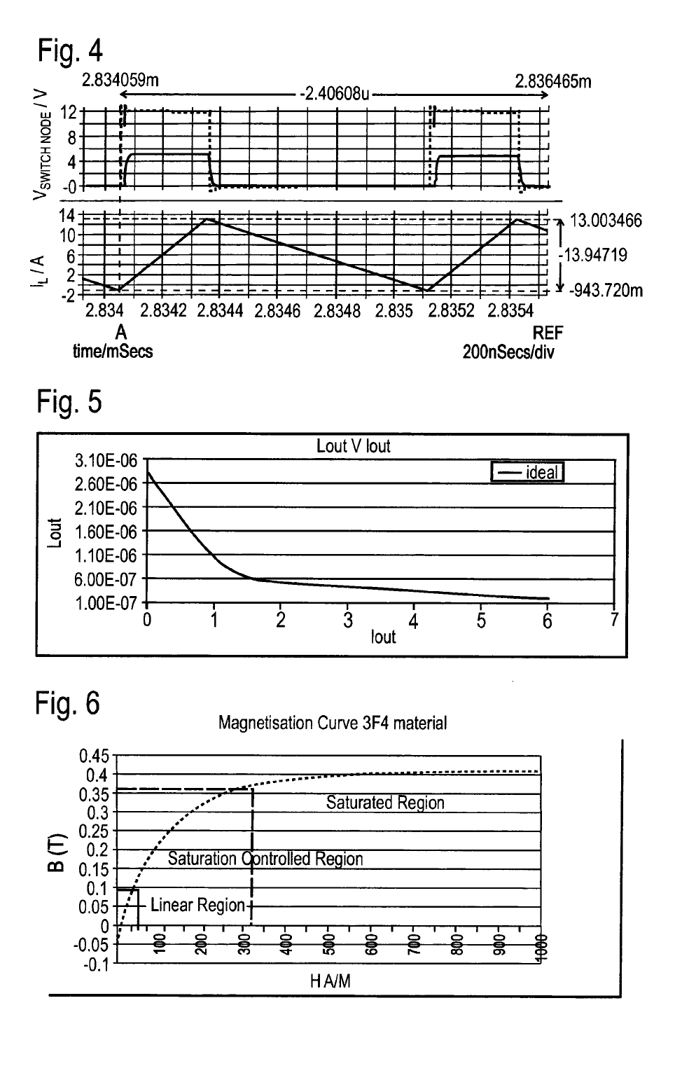

FIG. 4 (bottom) shows the inductor current. The low-side switch switch-off level has been set to 0.94A. FIG. 4 (top) shows the switch node voltage (solid line) and the high-side switch voltage (dotted line). The zero voltage switching action can be clearly seen. The switch node reaches the input voltage prior to the high-side switch is switched on.

In order to stabilize the switching frequency the non-linear inductor 25 is provided. In this device the inductance reduces as the current increases.

FIG. 5 shows the ideal inductance to load current relationship to maintain a constant switching frequency. In order to achieve this inductance variation, the non-linear inductor makes use of the magnetic saturation properties of the magnetic core material.

FIG. 6 shows the three regions found in soft magnetic materials. In the linear region, soft magnetic materials exhibit a linear relationship between flux density (B) and magnetic field strength (H) via the effective permeability (uₑ) of the material, giving a constant inductance. However once the flux density approaches the material's saturation density level begins to rapidly reduce, bringing about a reduction in inductance.

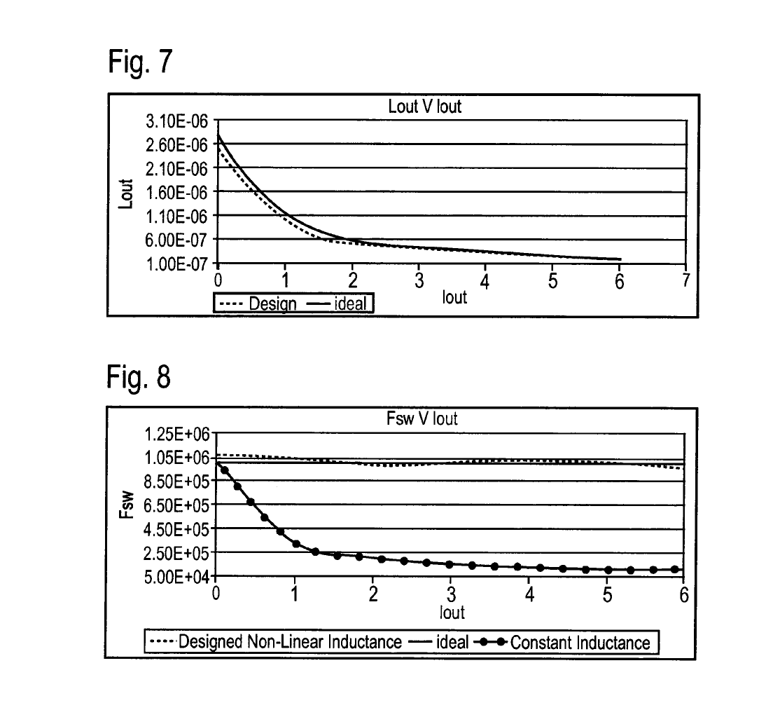

This saturation property is exploited in the non-linear inductor. These are designed with either the soft saturation material compositions or controlled saturations regions in the core and are designed to give a good fit to the ideal non-linear inductance required. FIG. 7 shows the calculated inductance variation of the non-linear inductor design and the ideal inductance.

Hence, the non-linear inductor may comprise a core of magnetic material and is configured to operate in a controlled saturation region of the magnetic material. Moreover, the non-linear may be configured such that it's inductance in function of the inductor current corresponds to a pre-calculated inductance. The pre-calculated inductance results in an inductor current to allow for a constant frequency operation of the buck converter.

FIG. 8 shows a comparison between switching frequency dependency to load current for a linear and a non-linear inductor. It can be observed that the designed non-ideal conductance fits closely to an ideal inductance that enables constant switching frequency operation of the buck-converter.

Compared with a linear inductance, a significant power saving can be achieved when employing a non-linear inductance in a buck converter employing zero voltage switching.

1. A switchable buck-converter with zero voltage switching capability comprising a non-linear inductor having an inductance as a function of a load current to allow for a constant switching frequency operation of the switchable buck-converter.

2. The switchable buck converter according to claim 1, comprising: an output stage for generating an output voltage according to a control signal and an input voltage via a switching element comprising a high-side switch and a low-side switch, each switch having respective first and second main terminals and a respective control terminal driven by a respective driver of the switchable buck converter configured according to the control signal;
the first main terminal of the low-side switch being connected to ground of the output stage;
the second main terminal of the low-side switch and the first main terminal of the high-side switch being connected to a switch node of the output stage;
the second main terminal of the high-side switch being connected to an input voltage terminal of the output stage;
the output stage comprising the non-linear inductor connected to the switch node and an output capacitor connected to ground of the output stage;
the buck-converter being operable in a charge phase with the high-side switch being switched on and the low-side switch being switched off;
the buck-converter being further operable in a discharge phase with the high-side switch being switched off and the low-side switch being switched on;
the drivers being configured to implement zero voltage switching by allowing an inductor current flowing to the switch node such that a voltage drop across the high-side switch is nearly zero when switching from the discharge phase to the charge phase.

3. The switchable buck-converter according to claim 2, wherein the low-side driver is configured to implement zero voltage switching by keeping the low-side switch switched on to allow the inductor current flowing to the switch node to reach a value of sufficient magnitude to drive a potential of the switch node back to the input voltage prior to switching on the high-side switch.

4. The switchable buck-converter according to claim 2, wherein the low-side driver is configured to implement zero voltage switching by keeping the low-side switch switched on until the inductor current flowing to the switch node exceeds a pre-determined value.

5. The switchable buck converter according to claim 2, wherein the low-side driver is configured to implement zero voltage switching by keeping the low-side switch switched on until a voltage drop across the low-side switch exceeds a threshold.

6. The switchable buck converter according to claim 5, wherein the low-side driver comprises
means for sensing the voltage drop across the low-side switch;
a comparator for comparing the voltage drop across the low-side switch against the threshold and
a latch for latching a drive signal of the low-side driver until the voltage drop across the low-side switch exceeds the threshold.

7. The switchable buck-converter according to claim 6, wherein the threshold has a value allowing zero voltage switching over a full input voltage range.

8. The switchable buck converter according to claim 1, wherein the non-linear inductor has an inductance in function of an inductor current such that the inductance reduces as the inductor current increases.

9. The switchable buck converter according to claim 8, wherein the non-linear inductor comprises a magnetic material.

10. The switchable buck converter according to claim 9, wherein the magnetic material exhibits a saturating relationship between flux density and magnetic field strength.

11. The switchable buck converter according to claim 10, wherein the non-linear inductor comprises a core of magnetic material and is configured to operate in a controlled saturation region of the magnetic material.

12. The switchable buck converter according to claim 10, wherein the non-linear inductor comprises soft saturation magnetic material compositions.

13. The switchable buck converter according to claim 11, wherein the non-linear inductor is configured such that its inductance as a function of the inductor current corresponds to a pre-calculated inductance.

14. The switchable buck converter according to claim 13, wherein the pre-calculated inductance results in an inductor current to allow for a constant frequency operation of the buck converter.

15. The switchable buck-converter according to claim 2, wherein the control signal is a pulse width modulation signal and wherein a drive signal of the high-side switch corresponds to the PWM signal and the drive signal of the low-side switch corresponds to the complement of the PWM signal.

16. The switchable buck converter according to claims 12, wherein the non-linear inductor is configured such that its inductance as a function of the inductor current corresponds to a pre-calculated inductance.

17. The switchable buck converter according to claim 16, wherein the pre-calculated inductance results in an inductor current to allow for a constant frequency operation of the buck converter.
